(19) United States
(12) Patent Application Publication
(10) Pub. No.: US 2025/0307919 A1
(43) Pub. Date: Oct. 2, 2025

(54) System and Method for Analysis of Consumer Credit Scores

(71) Applicant: Antoine Sallis, Temecula, CA (US)

(72) Inventor: Antoine Sallis, Temecula, CA (US)

(21) Appl. No.: 19/093,245

(22) Filed: Mar. 27, 2025

Related U.S. Application Data
(60) Provisional application No. 63/571,315, filed on Mar. 28, 2024.

(51) Int. Cl. G06Q 40/03

(52) U.S. Cl. CPC G06Q 40/03

(57) ABSTRACT

According to an aspect of the present invention, there is provided a method for analyzing credit profiles, comprising: training a machine learning model using a data set comprising a large number of consumer credit histories and credit scores; obtaining a user credit profile via an Application Programming Interface; and providing one or more AI-enabled predictions on how credit scores can be improved for the user.

### BACKGROUND

Credit scores are important to many persons because they significantly affect the ability to obtain loans and the interest rate charged.

The prior art patent literature describes systems and methods for optimizing the accuracy of credit scores. For example, US20180276748A1 provides an optimization method and apparatus for a credit score of a user, to effectively increase the accuracy of the credit score of the user. According to one aspect of the disclosure, an optimization method for obtaining a user credit score is provided. The method includes obtaining initial credit scores of users in multiple social-network user sets; obtaining initial credit scores of the social-network user sets according to the initial credit scores of the users; and determining a social-network relationship between each two social-network user sets according to a social-network relationship between the users in each two social-network user sets. The method also includes, according to a credit score of at least one social-network user set having a social-network relationship with a target social-network user set and the social-network relationship between the at least one social-network user set and the target social-network user set, optimizing and adjusting a credit score of the target social-network user set; and correcting credit scores of users in the target social-network user set according to the optimized and adjusted credit score of the target social-network user set.

Nonetheless, prior art methods and systems do not provide suggestions for improvement of credit scores or offer answers to questions about credit scores which many persons have given the complex nature of the scoring models.

### SUMMARY OF INVENTION

Therefore, the present invention provides a method and system for analyzing credit histories using machine learning and artificial intelligence and providing AI-enabled pointers on how credit scores can be improved for users of the system.

Another aspect of the system is a Large Language Model that is trained based on material provided by experts, e.g., books, pamphlets, and expert responses to example questions, to accurately answer user questions regarding credit scores.

### BRIEF DESCRIPTION OF THE DRAWINGS

FIG. 1 illustrates a credit simulator which predicts, using machine learning and artificial intelligence, the impact of various actions on the credit score of a user.

FIG. 2 illustrates an AI-chatbot known as the Credit Genius, which is trained using a Large Language Model to answer user questions regarding credit.

### DETAILED DESCRIPTION

In the existing technology, generally, to obtain credit assessment of a user, personal information of the user is collected, and then a default risk of the user is predicted by using a statistical model, for example, a frequently-used Vantage or FICO credit score system

The Vantage or FICO statistical model is often opaque since it is a confidential proprietary model and it is difficult to gauge how a person might take actions which will affect the Vantage or FICO score of the person.

The present invention, among other aspects, helps persons assess possible actions to be taken which can improve their Vantage or FICO scores. Embodiments illustrative of the present invention will be described with reference to the attached drawing.

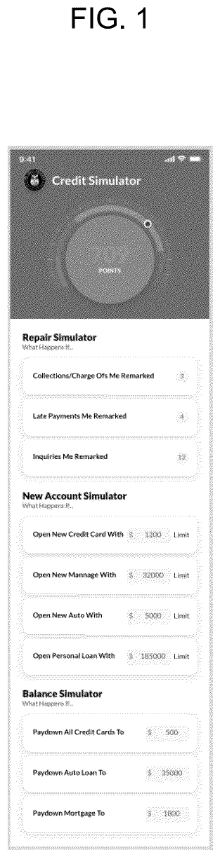

FIG. 1 illustrates a credit simulator which predicts, using machine learning and artificial intelligence, the impact of various actions on the credit score of a user.

The simulator is trained for machine learning using a data set comprising a large number of consumer credit histories and credit scores, which give the simulator artificial intelligence to be applied to any particular user.

The system is configured for obtaining a user credit profile via an Application Programming Interface and then applying the artificial intelligence simulator to it.

The consumer can use this simulator to model the impact on their score of paying off accounts in collection or charged off, decreased late payments, decreased inquiries, and opening various types of new loan accounts as well as reducing the balance on existing loan accounts of various types, all as can be seen in FIG. 1.

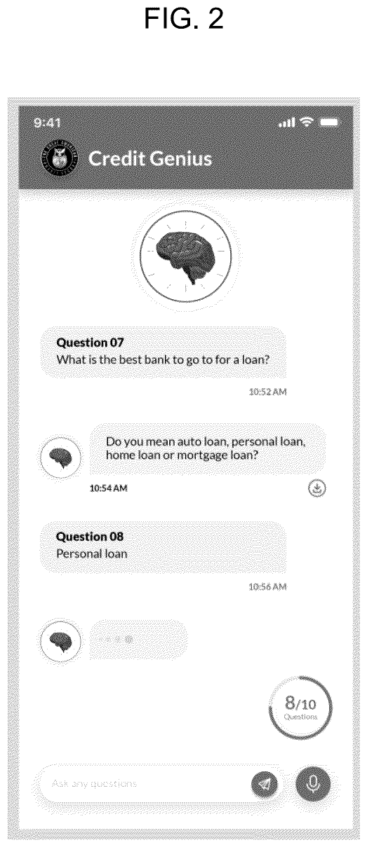

FIG. 2 illustrates an AI-chatbot known as the Credit Genius, which is trained using a Large Language Model to answer user questions regarding credit.

The credit genius is trained to answer queries as a Large Language Model using books, pamphlets, and expert responses to example questions, to accurately answer user questions regarding credit scores. The Large Language Model can then be manually adjusted to reflect the knowledge of a particular expert.

The user may enter free-form questions into the chat screen with the AI-enabled Credit Genius chatbot. The AI-enabled Credit Genius chatbot then utilizes the Large Language Model on which it is trained to parse the user's question and provide an appropriate answer.

In another embodiment of the present invention, credit games are made available to users. In credit games, users can undertake various simulations and answer various questions which the system can analyze using artificial intelligence to output projected credit scores.

All of the above embodiments are designed to be conducted with artificial intelligence and machine learning. In general, machine learning algorithms are used to make a prediction or classification regarding credit scores. Based on some input data, which can be labeled or unlabeled, the algorithm will produce an estimate about a pattern in the data.

An error function evaluates the prediction of the model. If there are known examples, an error function can make a comparison to assess the accuracy of the model. A model optimization process then occurs. If the model can fit better to the data points in the training set, then weights are adjusted to reduce the discrepancy between the known example and the model estimate. The algorithm will repeat this “evaluate and optimize” process, updating weights autonomously until a threshold of accuracy has been met.

Supervised learning in particular uses a training set to teach models to yield the desired output. This training dataset includes inputs and correct outputs, which enables the model to learn over time. The algorithm measures its accuracy through the loss function, adjusting until the error has been sufficiently minimized. Thus, through the computer-implemented process described above, the present invention can improve its ability to predict and detect e.g., matches.

After training, the machine learning categorization engine processes the sensor data using pre-trained models trained on datasets of credit score profiles and associated credit scores. It comprises an application-specific integrated circuit (ASIC) for an artificial neural network connected to the computer memory device, the ASIC comprising: a plurality of neurons organized in an array, wherein each neuron comprises a register, a processing element and at least one input, and a plurality of synaptic circuits, each synaptic circuit including a memory for storing a synaptic weight, wherein each neuron is connected to at least one other neuron via one of the plurality of synaptic circuits, wherein the array is configured to analyze said credit profile changes, wherein the AI/ML categorization engine makes a prediction regarding the credit scoring impact.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of skill in the art upon reviewing the above description. Other embodiments may be utilized and derived therefrom, such that structural and logical substitutions and changes may be made without departing from the scope of this disclosure. Figures are also merely representational and may not be drawn to scale. Certain proportions thereof may be exaggerated, while others may be minimized. Accordingly, the specification and drawings are to be regarded in an illustrative rather than a restrictive sense. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description. Therefore, it is intended that the disclosure not be limited to the particular embodiment(s) disclosed.

What is claimed is:

1. A method for analyzing credit profiles, comprising:
training a machine learning model using a data set comprising a large number of consumer credit histories and credit scores;
obtaining a user credit profile via an Application Programming Interface;
obtaining a simulated credit profile change; and
presenting the user credit profile and simulated credit profile change to an application-specific integrated circuit (ASIC) for an artificial neural network connected to the computer memory device, the ASIC comprising: a plurality of neurons organized in an array, wherein each neuron comprises a register, a processing element and at least one input, and a plurality of synaptic circuits, each synaptic circuit including a memory for storing a synaptic weight, wherein each neuron is connected to at least one other neuron via one of the plurality of synaptic circuits, wherein the array is configured to analyze said credit profile changes, wherein the AI/ML categorization engine makes a prediction regarding the credit scoring impact of the simulated credit profile change.

2. A method for answering user questions regarding credit, comprising:
training a Large Language Model that is trained based on material provided by experts, e.g., books, pamphlets, and expert responses to example questions, to accurately answer user questions regarding credit scores;
receiving a user question;
searching the Large Language Model to find an answer.
